(19) United States
(12) Patent Application Publication
(10) Pub. No.: US 2011/0281659 A1
(43) Pub. Date: Nov. 17, 2011

(54) UNIVERSAL JOINT

(76) Inventor: Daisuke YAMASHITA, Kakegawa-City (JP)

(21) Appl. No.: 13/098,806

(22) Filed: May 2, 2011

(30) Foreign Application Priority Data
May 6, 2010 (JP) 2010-106311

(51) Int. Cl. F16D 3/44

(52) U.S. Cl. 464/159

(57) ABSTRACT

An object oh this invention is to provide a universal joint capable of connecting first and second connecting members without using any pin and capable of easily preventing disconnection between the first and second connecting members. Therefore, a M member 20 serving as a second connecting member is formed with a torque transmitting part 21 inserted in a recessed part 11 of an F member 10 and having a maximum external contour part 21b between a distal end part 21a and a basal part 21c along the inserting direction. On the other hand, the F member 10 provided with a C-ring 40 at an inner peripheral surface on the opening side of the recessed part 11. When the torque transmitting part 21 of the M member 20 is inserted in the recessed part 11 of the F member 10, the distal end part 21a of the torque transmitting part 21 is abutted with a spring 30 and pushed toward the opening side of the recessed part 11 and a part from the basal part 21c of the torque transmitting part 21 to the maximum external contour part 21b is abutted with the C-ring 40, so that the torque transmitting part 21c of the M member 20 is prevented from escaping from the recessed part 11 of the F member 10.

### FIELD OF THE INVENTION

This invention relates to a universal joint capable of connecting a first connecting member and a second connecting member with at different angles.

### BACKGROUND OF THE INVENTION

A universal joint (this is also called as a universal socket, but in the present invention, it is generally referred to as a universal joint) is used as a torque transmitting tool (see, for example, Patent Document 1) or in other various technical fields such as in the field of connecting technology between an input shaft and an output shaft (see, for example, Patent Document 2).

### RELATED ART DOCUMENT PATENT DOCUMENTS

Patent Document 1: Japanese Patent Laid-Open Gazette No. 1995-96473

Patent Document 2: Japanese Patent Laid-Open Gazette No. 1997-68235

### SUMMARY OF THE INVENTION

However, the universal joint of Patent Document 1 has such a problem that since a pin is used for connecting the first and second connecting members, the torque transmitting force is limited by the strength of a pin, in the result the limit torque is decreased.

The universal joint of Patent Document 2 also has such a problem that although no pin is used for connecting an input shaft and an output shaft which correspond respectively to the first and second connecting members, the input shaft or the output shaft is disconnected easily.

It is, therefore, an object of the present invention to provide a universal joint capable of connecting first and second connecting members to each other without using any pin and capable of easily preventing disconnection between the first connecting member and the second connecting member.

According to the present invention, there is provided, in order to solve the above problem, a universal joint capable of connecting a first connecting member and a second connecting member with at different angles, wherein the first connecting member is formed with a recessed part, a spring is disposed in a deep part of the recessed part, the second connecting member is formed with a torque transmitting part which is inserted into the recessed part of the first connecting member and which has a maximum external contour part whose outside diameter is firstly gradually increased from a distal end part to a basal end part along the inserting direction and then gradually decreased. The first connecting member is provided at an inner peripheral surface on the opening side of the recessed part with an escape preventing part projecting inwardly from the inner peripheral surface and abutted with a part of the torque transmitting part from the basal part to the maximum external contour part. When the torque transmitting part is inserted in the recessed part of the first connecting member, the distal end part of the torque transmitting part is abutted with the spring and pushed toward the opening side of the recessed part and the part from the basal part to the maximum external contour part is abutted with the escape preventing part and as a result, the torque transmitting part of the second connecting member is prevented from escaping from the recessed part of the first connecting member.

It is also accepted that in the universal joint, the first connecting member is formed in an inner peripheral surface on the opening side of the recessed part with a ring groove extending in an inner peripheral direction, a ring groove is formed in the inner peripheral direction, a C-ring having a larger sectional diameter than the depth of the C-ring and serving as the escape preventing part is attached to the ring groove, the torque transmitting part of the second connecting member is inserted in the recessed part of the first connecting member, the distal end part of the torque transmitted part is abutted with the spring and pushed toward the opening side of the recessed part and the part from the basal part of the torque transmitting part to the maximum external contour part is abutted with the inner peripheral surface of the C-ring, so that the torque transmitting part of the second connecting member is prevented from escaping from the recessed part of the first connecting member.

It is also accepted that in the universal joint, an inclination angle of an outer peripheral surface from the basal part to the maximum external contour part with respect to a longitudinal axis of the torque transmitting part of the second connecting member is larger than an inclination angle of an outer peripheral surface from the distal end part to the maximum external contour part.

It is also accepted that in the universal joint, a vertical sectional configuration of the torque transmitting part of the second connecting member with respect to a longitudinal axis thereof is a generally regular hexagon, corner parts of six transmitting hill parts extending from six corners of the torque transmitting part to the distal end part and basal end part are each chamfered in a plane or a curved surface convexed to the outer side, and the torque transmitting part of the second connecting member is formed with six torque transmitting groove parts so that when inserted in the torque transmitting part of the second connecting part, the six torque transmitting groove parts are engaged with the six torque transmitting hill parts, respectively.

It is also accepted that in the universal joint, the first connecting member is formed on the side opposite the recessed part with a handle socket part to which a handle-side connecting part of a handle tip of a torque transmitting tool can be inserted, and the second connecting member is formed on the side opposite the torque transmitting part with a tool connecting part to which a tool-side socket part of various kinds of tools can be inserted.

According to a universal joint of the present invention, the first and second connecting members can be connected each other without using a pin, and the first and second connecting members can be prevented from disengaging easily.

### BRIEF DESCRIPTION OF THE DRAWINGS

FIGS. 1(a) and 1(b) are a side view and a partial sectional view of a connected condition of a universal joint 1, respectively, according to one embodiment of the present invention.

FIGS. 2(a) through (d) are a side sectional view, a rear view, a front view and an end view taken on line D-D, respectively, of the universal joint according to one embodiment of the present invention.

FIGS. 3(a) through 3(e) are a side view, a front view, a rear view, a sectional view taken on line E-E and a sectional view taken along line F-F, respectively, showing constitutional examples of a second connecting member (M member) of the universal joint according to one embodiment of the present invention.

FIGS. 4(a) through (c) are sectional views taken along line A-A, line B-B and line C-C, respectively, of FIG. 1(b) of the universal joint according to one embodiment of the present invention.

FIGS. 5(a) and 5(b) are a side view and a front view showing constitutional examples of a spring of the universal joint according to one embodiment of the present invention.

FIGS. 6(a) and 6(b) are a side view and a front view of a constitutional example of a C-ring serving as an escape preventing part of the universal joint according to one embodiment of the prevent invention.

FIG. 7 is a view showing one example of a sequential order for assembling the universal joint according to this embodiment.

FIGS. 8(a) and 8(b) are views showing examples in which the first connecting member (F member) and the second connecting member (M member) of the universal joint according to one embodiment of the present invention are connected with at different angles.

FIG. 9 is a view showing one example of a torque transmitting tool using the universal joint according to this embodiment.

### DESCRIPTION OF THE EMBODIMENTS

A universal joint 1 according to one embodiment of the present invention will now be described.

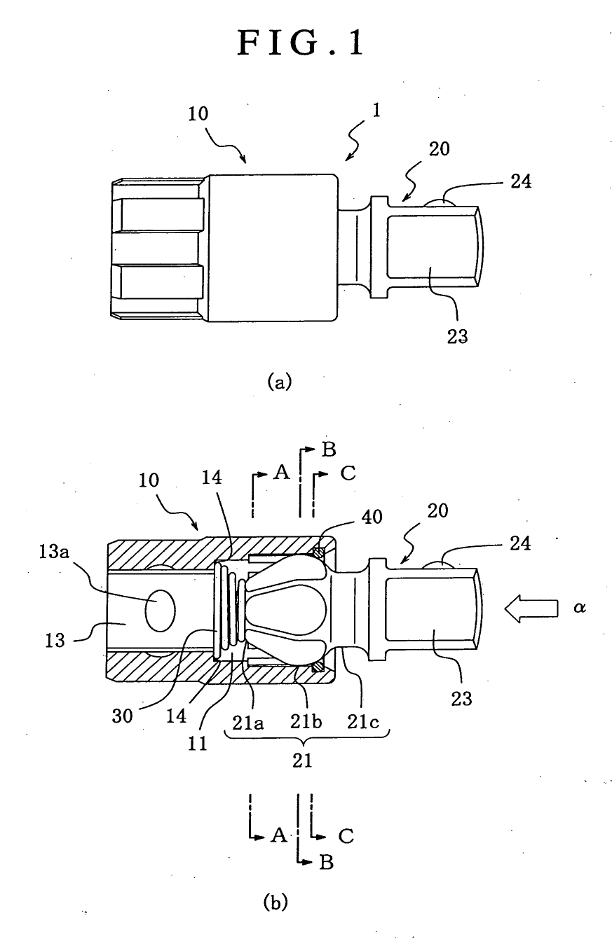

FIG. 1 is a diagram showing a connecting state of the universal joint 1 according to one embodiment of the present invention, FIG. 1(a) is a side view of the connecting state and FIG. 1(b) is a partial sectional view of the connecting state.

As shown in FIGS. 1(a) and 1(b), the universal joint 1 according to this embodiment includes an F member 10 serving as a first connecting member and an M member 20 serving as a second connecting member.

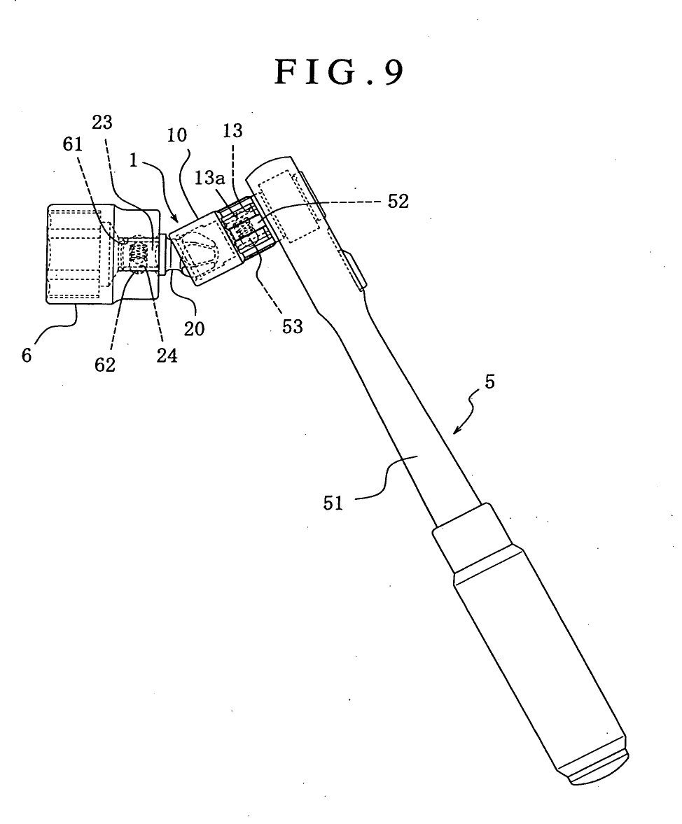

The F member 10 serving as a first connecting member has a recessed part 11 formed therein as shown in FIG. 1(b), and a spring 30 and a C-ring 40 serving as an escape preventing part, as later described, are inserted in the recessed part 11. A handle socket 13 is formed on the opposite side of the recessed part 11 in the F member 10. Inserted in the handle socket part 13 is a handle-side connecting part 52 at a distal end of a handle of a torque transmitting tool shown in FIG. 9 as later described. A ball retaining groove 13a, into which a steel ball 53, known per se, movable upward and downward by elastic force of a spring at the connecting part 52 on the handle side as later described with reference to FIG. 9 is formed in the handle socket part 13.

On the other hand, the M member 20 serving as the second connecting member is formed with a torque transmitting part 21 inserted in the recessed part 11 of the F member 10 in a direction as indicated by an arrow α and having a maximum external contour part 21b which is gradually increased and then decreased from the distal end part 21a toward the basal part 21c. The M member 20 is also provided with a tool connecting part 23. This tool connecting part 23 is formed on the side opposite the torque transmitting part 21 of the M member 20 and can be inserted into a tool-side socket part 61 on various tools 6 side. The tool connecting part 23 is provided with a steel ball 24, known per se, which is moved upward and downward under the effect of a spring and fitted to a ball retaining part 62 of the tool-side socket part 61. It should be noted, however, that although in this embodiment, the tool connecting part 23 and the handle-side connecting part 52 are provided with the known steel balls 24, 53, respectively, other elements such as pins which can be moved upward and downward may, of course, be provided instead of the steel balls 24, 25.

When the F member 10 and the M member 20 are in a connected condition as shown in FIGS. 1(a) and 1(b), the spring 30 is sandwiched and compressed between the distal end part 21a of the torque transmitting part 21 of the M member 20 and the spring stop part 14 serving as a bottom of the recessed part 11.

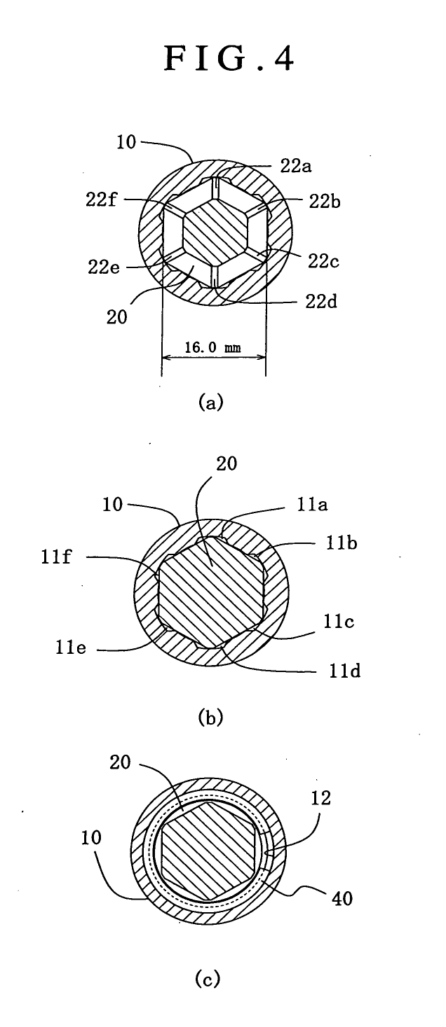

Therefore, although the spring 30 pushes the torque transmitting part 21 of the M member 20 toward the opening side of the recessed part 11, the torque transmitting part 21 is not escaped from the recessed part 11 of the F member 10 because the part of the torque transmitting part 21 of the M member 20 from the maximum external contour part 21b to the basal part 21c contacts the inner peripheral surface of the C ring 40. The sectional views taken along line A-A, line B-B and line C-C will be described later with reference to FIG. 4.

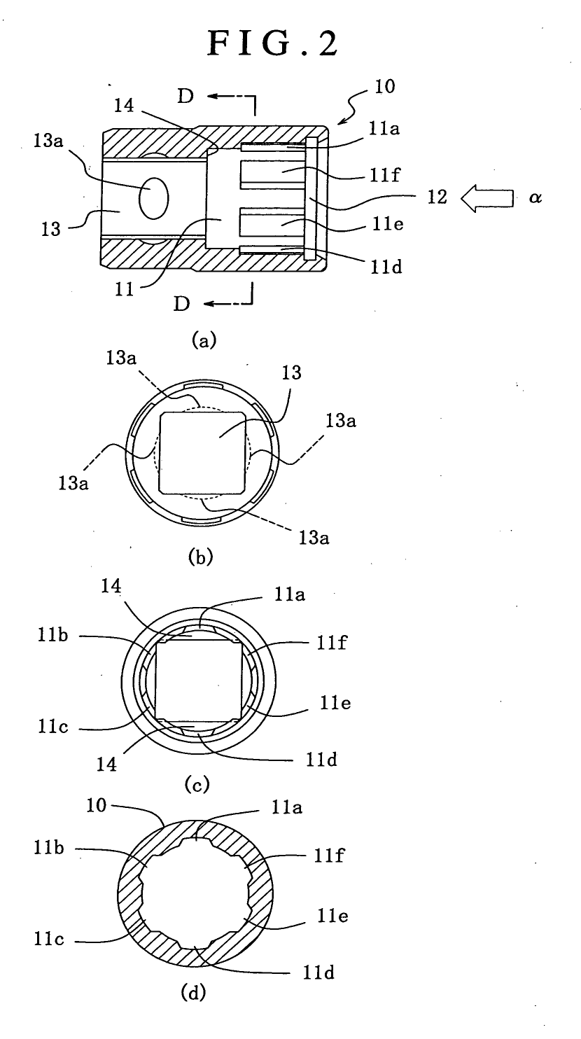

FIG. 2(a) through 2(d) are views respectively showing constitutional examples of the F member 10 serving as the first connecting member of the universal joint according to one embodiment of the present invention, FIG. 2(a) is a side sectional view of the F member 10, FIG. 2(b) is a rear view of the F member 10 of FIG. 2(a) when viewed from the left side, FIG. 2(c) is a front view of the F member 10 of FIG. 2(a) when viewed from the right side, and FIG. 2(d) is a sectional view taken along the line D-D of the F member of FIG. 2(A).

As shown in FIG. 2(a), a ring groove 12 is formed in the inner peripheral surface of the F member 10 on the opening side of the recessed part 11. The C ring 40 contacts the maximum external contour part 21b of the torque transmitting part 21 of the M member 20, so that the M member 20 is prevented from escaping in the opposite direction to the inserting direction a of the torque transmitting part 21. On the other hand, the F member 10 has the ring stop part 14 formed on its deep part of the recessed part 11.

As shown in FIGS. 2(c) and 2(d), torque transmitting groove parts 11a through 11f are formed in the inner peripheral surface of the recessed part 11 of the F member 10, torque transmitting groove parts 11a through 11f respectively engage with torque transmitting hill parts 22a through 22f formed on the outer surface of the torque transmitting part 21 of the M member 20 serving as the second connecting member and transmit torque to that, as later described.

As shown in FIGS. 2(a) and 2(b), the handle socket 13 and the ball retaining groove 13a are formed on the opposite side of the recessed part 11 in the F member 10. As already described with reference to FIG. 1, the handle-side connecting part 52 at a distal end of a handle of a torque transmitting tool shown in FIG. 9 as later described is inserted in the hand socket part 13. It should be noted that although the spaces in the recessed part 11 and the handle socket part 13 are continuous and formed in a cylindrical shape, it is also accepted that a wall or a bottom is disposed between the recessed part 11 and the handle socket part 13 so that the space in the recessed part 11 is divided from the space in the hand socket part 13.

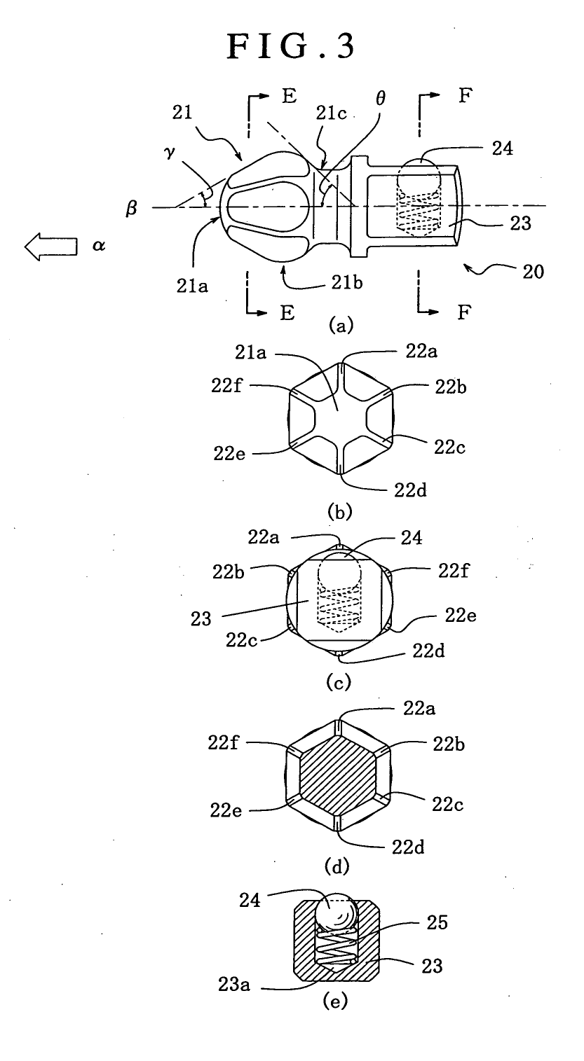

FIGS. 3(a) through 3(e) are views showing a constructive example of the M member 20 serving as the second connecting member of the universal joint 1 according to one embodiment of the present invention, FIG. 3(a) is a side view of the M member 20, FIG. 3(b) is a front view of the M member 20 when viewed from the left side of FIG. 3(a), FIG. 3(c) is a rear view of the M member 20 when viewed from the right side of FIG. 3(a), FIG. 3(d) is a sectional view of the M member 20 taken on line E-E of FIG. 3(a) and FIG. 3(e) is a sectional view of the M member 20 taken along line F-F of FIG. 3(a).

As described with reference to FIG. 1, the M member 20 as the second connecting member is formed with the torque transmitting part 21 having the maximum external contour part 21b which is gradually increased and then decreased from the distal end part 21a toward the basal part 21c along the inserting direction as indicated by an arrow α of FIG. 3(a)

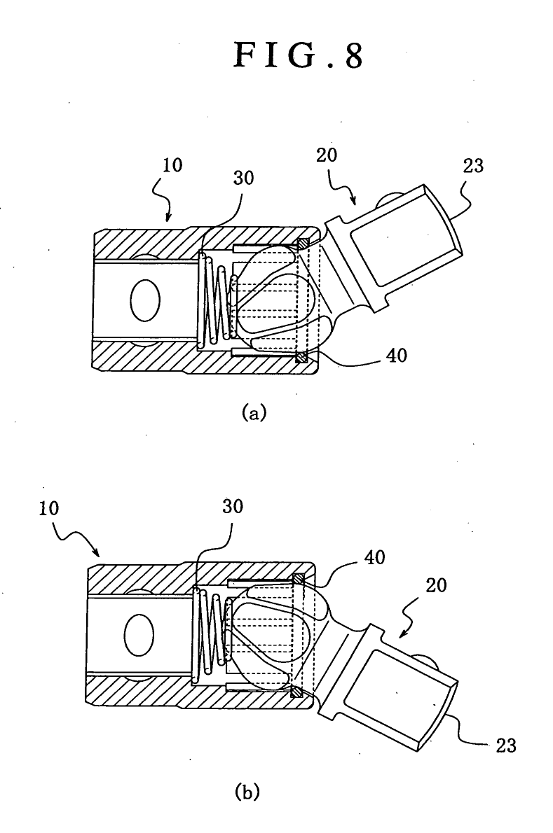

In this embodiment, the configuration of the outer peripheral surface of the torque transmitting part 21 of the M member 20 is formed such that the configuration of the outer peripheral surface from the distal end part 21a to the maximum external contour part 21b is a generally regular hexagon in which each corner and each distal end are chamfered, and the configuration of the outer peripheral surface from the maximum external contour part 21b to the basal part 21c is a generally hemispherical shape in which each corner is chamfered. Accordingly, in this embodiment, the torque transmitting part 21 of the M member 20 is formed in a tapered shape in which an inclination angle γ of the outer peripheral surface of the torque transmitting part 21 form the distal end part 21a to the maximum external contour part 21b with respect to a longitudinal axis β of the torque transmitting part 21 is smaller than an inclination angle θ of the outer peripheral surface from the basal part 21c to the maximum external contour part 21b. Owing to the foregoing arrangement, the M member 20 is connected to the F member 10 in a stable manner, i.e., in such a manner that the M member 20 is reliably prevented from escaping from the F member 10 by the C-ring 40, even when the M member 20 is connected to the F member 10 with at different angles as later described with reference to FIG. 8. Thus, torque can be transmitted from the torque transmitting member 21 of the M member 20 to the F member 10 in a stable manner. It should noted that relation between the inclination angles θ and γ is only one example and that the inclination angles θ and γ may be equal to each other.

The vertical sectional configuration of the torque transmitting part 21 of the M member 20 with respect to the longitudinal axis β thereof is formed in a hexagon as shown in FIGS. 3(b) through 3(d), etc. The respective corners of the hexagon are formed with corresponding six transmitting hill parts 22a through 22f continuous from the distal end part 21a to the basal part 21c via the maximum external contour part 21b, in order to transmit torque. Owing to the foregoing arrangement, the six torque transmitting hill parts 22a through 22f of the torque transmitting part 21 of the M member 20 are engaged respectively with the torque transmitting groove parts 11a through 11f formed in the inner peripheral surface of the recessed part 11 of the F member 10, so that torque can be transmitted between the F member 10 and the M member 20.

In this embodiment, the distal end part 21a of the torque transmitting part 21 and the corner parts of the six transmitting hill parts 22a through 22f part are each chamfered in a plane or a curved surface convexed to the outer side. Since the corner parts of the torque transmitting hill parts 22a through 22f each are chamfered in a plane or a curved surface convexed to the outer side, idling rotation can be prevented by preventing damage or wear of the six transmitting hill parts 22a through 22f of the torque transmitting part 21 of the M member 20 even when transmission of torque between the F member 10 and the M member 20 and connection thereof with at different angles are repeatedly made. It is optional in this embodiment that the distal end part 21a of the torque transmitting part 21 and the corner parts of the six transmitting hill parts 22a through 22f part are each chamfered in a plane or a curved surface convexed to the outer side and they may be not chamfered.

As already described with respect FIG. 1, a tool connecting part 23 inserted in a tool-side socket part 61 (see FIG. 9) on the side of various tools 6 and a steel ball 24 pushed upward in FIG. 9 by elastic force of a spring received in a spring receiving part 23a are disposed on the side opposite the torque transmitting part 21 of the M member 20 as shown in FIGS. 3(a) through 3(c).

FIGS. 4(a) through 4(c) are sectional views taken respectively along lines A-A, B-B and C-C of the universal joint according to this embodiment of FIG. 1(b).

As shown in FIGS. 4(a) through 4(c), the vertical sectional configuration of the torque transmitting part 21 of the M member 20 with respect to a longitudinal direction thereof is formed in a generally regular hexagon. The torque transmitting part 21 of the M member 20 is provided with torque transmitting hill parts 22a through 22f obtained by chamfering the corner parts of the hexagon in a plane or a curved surface convexed to the outer side, so that the torque transmitting hill parts 22a through 22f are engaged respectively with the torque transmitting groove parts 11a through 11f in order to transmit torque between the F member 10 and the M member 20.

As shown in FIG. 4(c), the part from the basal part 21c of the torque transmitting part 21 to the maximum external contour part 21b is abutted with the C-ring 40 so that the M member 20 is prevented from escaping from the recessed part 11 of the F member 10.

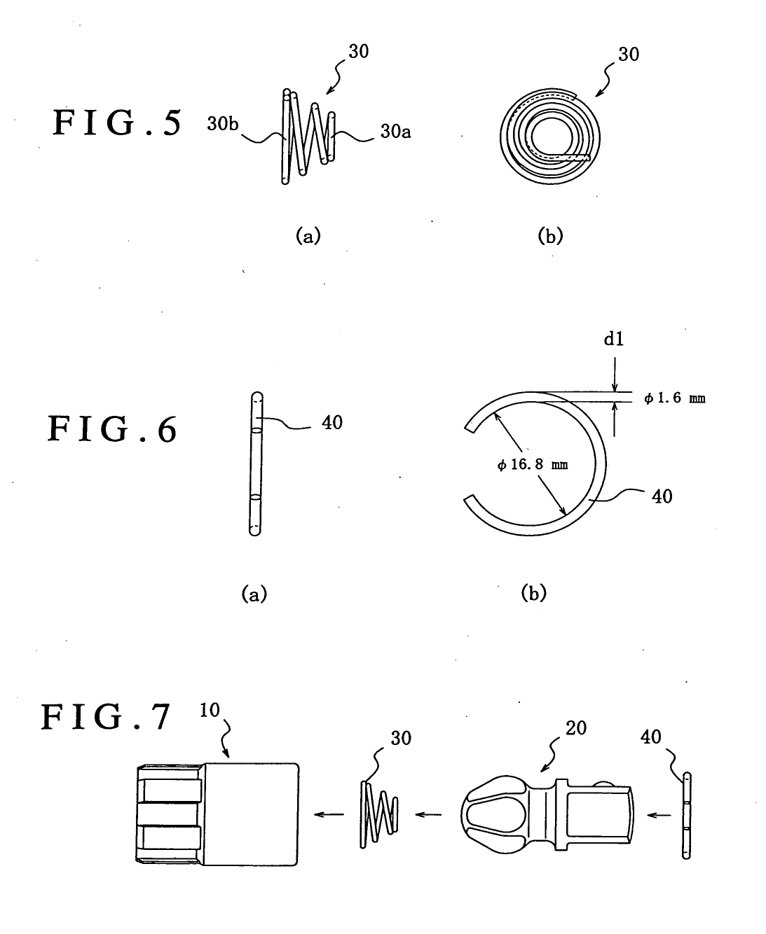

FIGS. 5(a) and 5(b) are views showing one example of a spring 30 inserted in the recessed part 11 of the F member 10, FIG. 5(a) is a side view of the spring 30 and FIG. 5(b) is a front view of the spring 30.

As shown in FIGS. 5(a) and 5(b), the spring 30 for inserting in the recessed part 11 of the F member 10 is formed in such a configuration that the distal end part 38a is small in diameter and the diameter is increased toward the rear end part 30b in conformity with the size of the distal end part 21a of the torque transmitting part 21 of the M member 20. It should be noted, however, that the configuration of the spring 30 is only one example and that it may take any other configuration as long as the spring 30 can push the torque transmitting part 21 of the M member 20 reliably in an opposite direction to the inserting direction.

FIGS. 6(a) and 6(b) are views showing one example of a C-ring serving as an escape preventing part, which is to be inserted in the ring groove 12 of the recessed part 11 of the F member 10, FIG. 6(a) is a side view of the C-ring 60 and FIG. 6(b) is a front view of the C-ring.

As shown in FIG. 6, the C-ring 40 which is to be inserted in the ring groove 12 of the recessed part 11 of the F member 10 is a ring made of metal and having a ring-like (arc) configuration partly cutaway, and it has a sectional diameter d1 larger than the depth of the groove of the ring groove 12. For example, if the depth of the groove of the ring groove 12 is 0.8 mm, the sectional diameter d1 of the C-ring 40 is 1.6 mm. Likewise, if the depth of the maximum external contour part 21b of the torque transmitting part 21 of the M member 20 and the length of the recessed part 11 of the F member 21 are, for example, 16.0 mm, the inside diameter of the C-ring 40 is 16.8 mm. Accordingly, when the C-ring 40 is bent inward and fitted to the ring groove 12 of the recessed part 11 of the F member 10, it becomes smaller than the outside diameter of the maximum external contour part 21b of the torque transmitting part 21 of the M member 20 and thus, the torque transmitting part 21 of the M member 20 can be prevented from escaping from the recessed part 11 of the F member 10 reliably. It should be noted, however, that those dimensions are only one example and that the present invention is not limited to them.

FIG. 7 is a view showing one example of assembling order of the universal joint 1 according to this embodiment.

Specifically, as shown in FIG. 7, first, the spring 30 is inserted in a deep bottom part 14 of the recessed part 11 of the F member 10 and then, the torque transmitting part 21 of the M member 20 is inserted therein such that the spring 30 is compressed by the distal end part 21a. Lastly, the C-ring 40 is inserted and fitted to the ring groove 12 of the recessed part 11. By doing so, when the torque transmitting part 21 of the M member 20 is inserted in the recessed part 11 of the F member 10, the distal end part 21a of the torque transmitting part 21 is normally pushed in the direction of the opening side of the recessed part 11 by the elasticity of the spring 30, the part from the basal part 21c of the torque transmitting part 21 to the maximum external contour part 21b is abutted with the C-spring 40 and the torque transmitting part 21 is sandwiched between the spring 30 and the C-ring 40, thereby preventing the escaping of the M member 20 from the F member 10.

FIGS. 8(a) and 8(b) are views showing a contacting state of the outer peripheral surface of the torque contacting part 21 with the inner peripheral surface of the recessed part 11 of the F member 11 when the attaching angle of the M member 20 serving as the second connecting member is changed with respect to the F member 10 serving as the first connecting member.

Specifically, FIG. 8(a) shows a contacting state of the outer peripheral surface of the torque transmitting part 21 with the inner peripheral surface of the recessed part 11 of the F member 10 when the attaching angle of the M member 20 is bent upward in FIG. 8(a) with respect to the F member 10, and FIG. 8(b) shows a contacting state of the outer peripheral surface of the torque transmitting part 21 with the inner peripheral surface of the recessed part 11 of the F member 10 when the attaching angle of the M member 20 is bent downward in FIG. 8(b) with respect to the F member 10.

As apparent from the two cases shown in FIGS. 8(a) and 8(b), in this embodiment, since the inclination angle γ of the outer peripheral surface from the distal end part 21a to the maximum external contour part 21b in the torque transmitting part 21 of the M member 20 is set smaller than the inclination angle θ of the outer peripheral surface from the basal part 21c to the maximum external contour part 21b (see FIG. 3(A)), the contacting areas of the torque transmitting hill parts 22a through 22f of the M member 20 engaged respectively with the torque transmitting groove parts 11a through 11f of the F member 10 are increased when the attaching angle of the M member 20 with respect to the F member 10 is changed, compared with the case wherein the M member 20 is linearly connected to the F member 10 of FIG. 1. Owing to the foregoing arrangement, torque can be transmitted in a more reliable manner even when the attaching angle of the M member 20 with respect to the F member 10 is changed. When the vertical sectional configuration of the torque transmitting part 21 of the M member 20 with respect to the direction of the axis β thereof is generally circular, the contacting areas of the torque transmitting hill parts 22a through 22f of the M member 20 respectively engaged with the torque transmitting groove parts 11a through 11f of the F member 10 are not changed regardless of whether the attaching angle of the M member 20 with respect to the F member 10 is changed or not, and thus, torque can be transmitted with the same amount of force.

FIG. 9 is a view showing one example of a ratchet wrench 5 as one example of a torque transmitting tool using the universal joint 1 according to this embodiment.

As shown in FIG. 9, in the ratchet wrench 5, for setting the various tools 6, the tool connecting part 23 of the M member 20 of the universal joint according to this embodiment is inserted in the tool-side socket part 61 of the various tools 6 and the steel ball 24 of the tool connecting part 23 is fitted to the ball retaining groove 62 of the tool-side socket part 61. On the other hand, the handle-side connecting part 52 at a tip end of the ratchet handle 51 is inserted in the handle socket part 13 of the F member 10 and the steel ball 53 of the handle-side connecting part 52 is fitted to the ball retaining groove 13a of the handle socket part 13. By doing so, the ratchet wrench 5 is assembled.

In the ratchet wrench 5 thus assembled according to this embodiment, a bolt, a screw, etc. can be turned by transmitting torque thereto, while freely changing the angle of the tool 6 by the universal joint 1 according to this embodiment. It should be noted, however, that one example of the ratchet wrench 5 is described as one example of a torque transmitting tool using the universal joint 1 according to this embodiment here, the present invention is not limited to this and it can, of course, be applied to other torque transmitting tools such as, for example, a T-type wrench.

Thus, according to the universal joint 1 of this embodiment, the M member 20 serving as the second connecting member is formed with the torque transmitting part 21 which is inserted in the recessed part 11 of the F member 10 serving as the first connecting member and having the maximum external contour part 21b between the distal end part 21a and the basal part 21c, the outside diameter of which maximum external contour part 21b is gradually increased and the gradually decreased along the inserting direction. On the other hand, the F member 10 is provided at the inner peripheral surface on the opening side of the recessed part 11 with the C-ring 40 serving as the escape preventing part which is abutted with the maximum external contour part 21b of the torque transmitting part 21 so as to prevent the torque transmitting part 21 from escaping from the F member 10 in the opposite direction to the inserting direction of the torque transmitting part 21. When the torque transmitting part 21 of the M member 20 is inserted in the recessed part 11 of the F member 10, the distal end part 21a of the torque transmitting part 21 is abutted with the spring 30 and pushed toward the opening side of the recessed part 11, and the part from the basal part 21c of the torque transmitting part 21 to the maximum external contour part 21b is abutted with the C-ring 40 serving as the escape preventing part so as to prevent the torque transmitting part 21 of the M member 20 serving as the second connecting member from escaping from the recessed part 11 of the F member 10 serving as the first connecting member. Accordingly, the first connecting member and the second connecting member can be connected to each other without using any pin, and the first and second connecting members can easily be prevented from being disconnected from each other.

In particular, in this embodiment, since the inclination angle γ of the outer peripheral surface from the distal end part 21a of the torque transmitting part 21 of the M member 20 to the maximum external contour part 21b is set smaller than the inclination angle θ of the outer peripheral surface from the basal part 21c to the maximum external contour part 21b, the contacting area of the torque transmitting hill parts 22a through 22f of the M member 20 engaged respectively with the torque transmitting groove parts 11a through 11f of the F member 10 more in the case where the attaching angle of the M member 20 with respect to the F member 10 is changed than in the case where the M member 20 is connected straight to the F member 10. Thus, torque can be transmitted more reliably.

Moreover, in this embodiment, since the handle socket part 13 in which the handle-side connecting part 52 at the tip end of the handle 51 of a torque transmitting tool such as a ratchet wrench is inserted is formed on the side opposite the recessed part 11 of the F member 11 and the tool connecting part 23 which is inserted in the tool-side socket part 61 of various tools 6 is formed on the side opposite the torque transmitting part 21 of the M member 20, a cavity (clearance) defined by the recessed part 11 and the handle socket part 13 in the F member 10 can be continuously formed and the torque transmitting part 21 and the tool connecting part 23 can be continuously formed in the M member 20, the F member 10 and the M member 20 can be manufactured easily.

It should be noted, however, that, in the universal joint 1 according to this embodiment, although the C-ring 40 serving as the escape preventing part is described as one example, the present invention is not limited to this, and any other means such as, for example, an escape preventing piece, an escape preventing pin or the like may, of course, be employed as long as they can prevent the M member 20 from escaping from the recessed part 11 of the F member 10 by being abutted with the part from the basal part 21 of the torque transmitting part 21 to the maximum external contour part 21b.

Moreover, in the universal joint 1 according to this embodiment, although the handle socket part 13 is formed on the side opposite the recessed part 11 of the F member 10 and the tool connecting part 23 is formed on the side opposite the transmitting part 21 of the M member 20, the present invention is not limited to this. It is, of course, accepted that the tool connecting part 23 is formed on the side opposite the recessed part 11 of the F member 10 and the handle socket part 13 is formed on the side opposite the torque transmitting part 21 of the M member 20.

### DESCRIPTION OF REFERENCE NUMERAL

1 . . . universal joint
10 . . . F member (first connecting member)
11 . . . recessed part
11a through 11f . . . torque transmitting groove parts
12 . . . ring groove
13 . . . handle socket part
20 . . . M member (second connecting member)
21 . . . torque transmitting part
21a . . . distal end part
21b . . . maximum external contour part
21c . . . basal part
22a through 22f . . . torque transmitting hill parts
23 . . . tool connecting part
24 . . . steel ball
30 . . . spring
40 . . . C-ring (escape preventing part)
5 . . . ratchet wrench
51 . . . ratchet handle
52 . . . handle-side connecting part

1. A universal joint capable of connecting a first connecting member and a second connecting member with at different angles, wherein
said first connecting member is formed with a recessed part, a spring is disposed in a deep part of said recessed part;
said second connecting member is formed with a torque transmitting part which is inserted into said recessed part of said first connecting member and which has a maximum external contour part whose outside diameter is firstly gradually increased from a distal end part to a basal end part along the inserting direction and then gradually decreased;
said first connecting member is provided at an inner peripheral surface on the opening side of said recessed part with an escape preventing part projecting inwardly from the inner peripheral surface and abutted with a part of said torque transmitting part from said basal part and to said maximum external contour part;
when said torque transmitting part is inserted in said recessed part of said first connecting member, said distal end part of said torque transmitting part is abutted with said spring and pushed toward the opening side of said recessed part and said part from said basal part to said maximum external contour part is abutted with said escape preventing part and as a result, said torque transmitting part of said second connecting member is prevented from escaping from said recessed part of said first connecting member.

2. The universal joint according to claim 1, wherein
said first connecting member is formed in an inner peripheral surface on the opening side of said recessed part with a ring groove extending in an inner peripheral direction, a ring groove is formed in the inner peripheral direction, and a C-ring having a larger sectional diameter than the depth of said C-ring and serving as said escape preventing part is attached to said ring groove; and
said torque transmitting part of said second connecting member is inserted in said recessed part of said first connecting member, said distal end part of said torque transmitted part is abutted with said spring and pushed toward the opening side of said recessed part and said part from said basal part of said torque transmitting part to said maximum external contour part is abutted with the inner peripheral surface of said C-ring, so that said torque transmitting part of said second connecting member is prevented from escaping from said recessed part of said first connecting member.

3. The universal joint according claim 1, wherein an inclination angle of an outer peripheral surface from said basal part to said maximum external contour part with respect to a longitudinal axis of said torque transmitting part of said second connecting member is larger than an inclination angle of an outer peripheral surface from said distal end part to said maximum external contour part.

4. The universal joint according claim 1, wherein
a vertical sectional configuration of said torque transmitting part of said second connecting member with respect to a longitudinal axis thereof is a generally regular hexagon, and corner parts of six transmitting hill parts extending from six corners of said torque transmitting part to said distal end part and said basal end part are each chamfered in a plane or a curved surface convexed to the outer side; and
said torque transmitting part of said second connecting member is formed with six torque transmitting groove parts so that when inserted in said torque transmitting part of said second connecting part, said six torque transmitting groove parts are engaged with said six torque transmitting hill parts, respectively.

5. The universal joint according to claim 1, wherein
said first connecting member is formed on the side opposite said recessed part with a handle socket part to which a handle-side connecting part of a handle tip of a torque transmitting tool can be inserted; and
said second connecting member is formed on the side opposite said torque transmitting part with a tool connecting part to which a tool-side socket part of various kinds of tools can be inserted.
